(19) United States
(12) Patent Application Publication
(10) Pub. No.: US 2018/0190125 A1
(43) Pub. Date: Jul. 5, 2018

(54) REAL-TIME RELATIVE VEHICLE TRAJECTORIES USING VEHICLE TO VEHICLE COMMUNICATION

(71) Applicant: Regents of the University of Minnesota, Minneapolis, MN (US)

(72) Inventors: M. Imran Hayee, Minneapolis, MN (US); Zhiyuan Peng, Minneapolis, MN (US); Max Donath, Minneapolis, MN (US)

(21) Appl. No.: 15/858,717

(22) Filed: Dec. 29, 2017

Related U.S. Application Data
(60) Provisional application No. 62/439,932, filed on Dec. 29, 2016.

(51) Int. Cl. G08G 1/16

(52) U.S. Cl. CPC G08G 1/167; G08G 1/166; G08G 1/161

(57) ABSTRACT

Position coordinates from a second vehicle are received at a first vehicle using a dedicated short range communication protocol. The position coordinates from the second vehicle include an error. Position coordinates for the first vehicle are received from a positioning system in the first vehicle where the position coordinates for the first vehicle also includes the error. The position coordinates from the second vehicle and the position coordinates from the first vehicle are used to determine a relative distance and orientation between the first vehicle and the second vehicle such that the error is reduced in the relative distance and orientation.

### CROSS-REFERENCE TO RELATED APPLICATION

The present application is based on and claims the benefit of U.S. provisional patent application Ser. No. 62/439,932, filed Dec. 29, 2016, the content of which is hereby incorporated by reference in its entirety.

### BACKGROUND

Satellite-based position systems, such as the Global Positioning System (GPS), receive clock signals from satellites and use the clock signals to identify a position in three-dimensional space. While satellite-based position systems have been used with vehicle navigation systems, current systems are unable to determine what lane of traffic a vehicle is in. This means that satellite-based position systems cannot be used in anti-collision systems on vehicles without any augmentation method.

Dedicated Short Range Communication (DSRC) is a short range wireless communication protocol that has been developed specifically for vehicle-to-vehicle or vehicle-to-infrastructure communication. It allows vehicles to communicate with other nearby vehicles and with various infrastructure such as road signs.

### SUMMARY

Position coordinates from a second vehicle are received at a first vehicle using a dedicated short range communication protocol. The position coordinates from the second vehicle include an error. Position coordinates for the first vehicle are received from a positioning system in the first vehicle where the position coordinates for the first vehicle also includes the error. The position coordinates from the second vehicle and the position coordinates from the first vehicle are used to determine a relative distance and orientation between the first vehicle and the second vehicle such that the error is reduced in the relative distance and orientation.

In a further embodiment, a vehicle includes a positioning system providing coordinates for a position of the vehicle, the coordinates having a first accuracy and a communication system receiving coordinates for a position of a second vehicle from the second vehicle. A processor uses the coordinates for the position of the vehicle and the coordinates for the position of the second vehicle to determine a distance between the vehicle and the second vehicle, where the distance has a second accuracy that is more accurate than the first accuracy.

In a still further embodiment, a system includes a position system that identifies a position of a vehicle, where the identified position includes an error and a communication system that transmits the position of the vehicle and that receives a position of a second vehicle, where the received position of the second vehicle includes the same error as the identified position of the vehicle. A processor uses the identified positions of the vehicle and the second vehicle to determine a distance and orientation of the second vehicle relative to the first vehicle such that the error is reduced in the distance and orientation.

### BRIEF DESCRIPTION OF THE DRAWINGS

FIGS. 1(a) and 1(b) show errors in GPS positions for a stationary and moving vehicle, respectively.

FIG. 2(a) shows errors in GPS positions for a vehicle merging into traffic.

FIG. 2(b) shows errors in GPS positions for vehicles on a three-lane road.

FIG. 3 shows a graphical depiction of positions of GPS receivers on a vehicle for testing.

FIG. 4 shows histograms for distance measurements made between the GPS receivers of FIG. 3.

FIG. 5(a) shows a depiction of calculated trajectories based on two sets of coordinates for two different vehicles.

FIG. 5(b) shows a histogram of differential headings measured between two GPS receivers that are moving together on a same vehicle.

FIG. 6 shows a section of two roads with graphics overlaid showing trajectories determined using methods in accordance with one embodiment.

FIG. 7 shows the timing relationship between position coordinates determined for three different vehicles during a merge using methods in accordance with one embodiment.

FIG. 8 provides a block diagram of elements used in a system in accordance with one embodiment.

### DETAILED DESCRIPTION OF ILLUSTRATIVE EMBODIMENTS

The Intelligent Transportation Systems Joint Program Office (ITSJPO) of the US Department of Transportation (USDOT) continues to be committed to the use of dedicated short range communication (DSRC) for active safety applications using vehicle-to-vehicle (V2V) and/or vehicle-to-infrastructure (V2I) communication due to its designated licensed bandwidth, fast network acquisition, and low latency. A USDOT research report estimates that V2V communication has the potential to help drivers avoid or mitigate 70 to 80 percent of vehicle crashes involving unimpaired drivers, which could help prevent thousands of deaths and injuries on roads every year. To take full advantage of the potential safety benefits of connected vehicle technology, relative trajectories of the surrounding vehicles with lane-level resolution are needed in addition to V2V communication. Accurate positioning information with lane-level resolution can enable many vehicular safety applications (e.g., freeway merge-assist, lane-change-assist, and lane-departure warning systems), which could potentially help avoid many crashes. According to one study, 36 percent of the freeway accidents analyzed occurred on entrance ramps, and another study reported that 20-30 percent of total truck accidents nationwide occur on or near ramps. Similarly, in 1991, lane-change accidents accounted for approximately 4 percent of all police-reported crashes that occurred in the United States; in 1999, those accidents rose to 9 percent. Another report that analyzed crash data from 2005 to 2007 concluded that 11 percent of vehicles involved in an accident had failed to stay in the proper lane.

An important technological milestone in the development of a lane-change or merge-assist application is to acquire the relative positions of surrounding vehicles in real time. Accurate positioning information can be obtained using either sensor-based systems or Global Navigation Satellite Systems (GNSSs). Both approaches have their limitations. Sensor-based systems utilize vision-based or laser-based sensors to acquire the relative positions of surrounding vehicles. However, environmental factors such as weather, variable lighting conditions, absence of line-of-sight (LoS), or worn out road markings can adversely affect the performance of these systems. Similarly, GNSS-based technologies such as Global Positioning System (GPS) cannot predict the position of a vehicle with lane-level accuracy without using a correction or augmentation system e.g., differential GPS technology (where a fixed GPS receiver with a known position transmits correction data to correct the satellite clock signals), inertial sensors, gyroscope, and/or high-resolution maps. Furthermore, the deployment of either sensor-based or GPS-based system requires sophisticated hardware and software, resulting in increased complexity and higher overall costs.

The above-mentioned techniques can obtain the precise absolute position of a vehicle at the expense of cost and complexity. However, some critical safety applications such as merge-assist or lane-change-assist systems require only the relative positions of surrounding vehicles with lane-level resolution to allow a given vehicle to differentiate the vehicles in its own lane from the vehicles in adjacent lanes. Therefore, in the approach provided herein, we have focused on acquiring the relative trajectories of surrounding vehicles using standard GPS receivers—without any additional correction system—and DSRC-based V2V communication.

Our approach to acquire relative trajectories is based on the fact that a major part of GPS positioning error, caused by atmospheric effects, is highly correlated over a vast geographical area. Therefore, multiple GPS receivers of the same kind on different vehicles in close proximity tend to have a similar atmospheric error at a given time. In accordance with one embodiment, the common atmospheric error is canceled out to obtain a more accurate estimate of the relative distance between any two vehicles as compared to the absolute position of each vehicle. Utilizing this approach, several embodiments successfully acquire relative trajectories of vehicles traveling in multiple lanes toward a merging junction with an accuracy of ±0.5 m using DSRC-based V2V communication and standard GPS receivers. The accuracy of the acquired relative trajectory is sufficient to differentiate vehicles traveling in adjacent lanes of a multiple-lane freeway.

The next section describes the concept of relative GPS positioning among surrounding vehicles. The section after that discusses the results from field tests to statistically characterize the accuracy of the relative trajectories of multiple vehicles using standard GPS receivers. In the section after that, the results from field tests to acquire relative trajectories of surrounding vehicles with lane-level accuracy using DSRC-based V2V communication is discussed. The last section summarizes the conclusions.

### Concept of Relative GPS Positioning Among Surrounding Vehicles

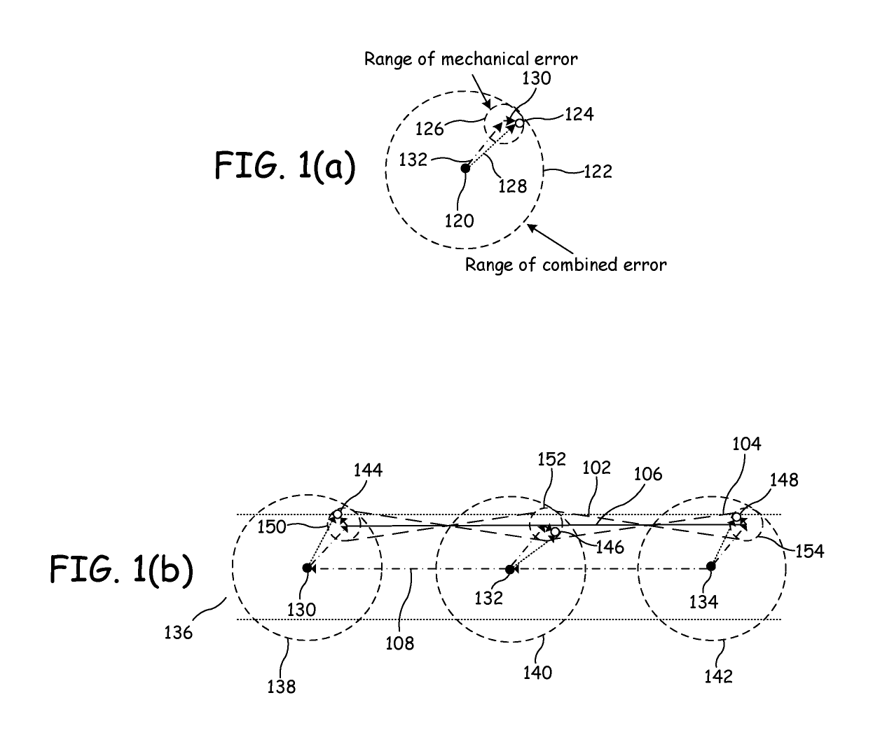

Our approach utilizes standard GPS receivers and DSRC-based V2V communication to acquire the relative trajectories of surrounding vehicles. The absolute position accuracy of a standard GPS receiver is in the range of 3-5 meters. This means that a GPS receiver can estimate the position of a vehicle within a circle with a radius of 3-5 meters, as shown in FIG. 1(a), where the true position of the vehicle at a given time is shown by dot 120 centered in the large circle 122 and the position estimated by the GPS receiver is shown by dot 124 in small circle 126. The error vector 128 from the true position to the estimated position represents the GPS position error. The total GPS position error is a combination of multiple errors resulting from different sources. Generally, the combined GPS position error is a result of mechanical error 130, and a combination of satellite ephemeris error and atmospheric error 132.

Mechanical GPS error is caused by inherent noise or clock jitter of the crystal oscillator used in the GPS receiver, thermal effects, manufacturing differences, and residual mathematical error due to quantization and rounding. Satellite ephemeris error is due to the fact that the expected orbital positions of the GPS satellites that the GPS receiver needs to estimate its own position could be different than actual satellite positions. Atmospheric error, the most significant portion of the combined GPS error, is caused by atmospheric effects that cause the GPS signal to bend while it travels through the atmosphere. Of all these errors, mechanical error is the only one that can vary randomly from one GPS receiver to another at any given time. It can also vary in the same GPS receiver with each subsequent position estimate over time. On the other hand, both ephemeris and atmospheric errors do not vary significantly for multiple GPS receivers in close geographical and temporal proximity. This is because atmospheric disturbances will remain the same over a wide geographical area and do not rapidly change with time. Similarly, ephemeris error will remain almost the same for the satellite constellation used by GPS receivers in close proximity to each other. Theoretically, a GPS-estimated position can be anywhere in larger circle 122, representing the range of combined GPS errors. However, after a GPS receiver gets locked to certain satellites to estimate its position, its subsequent position estimates will not randomly vary over the entire large circle 122 because atmospheric and ephemeris errors will remain the same for a considerable period of time. On the other hand, mechanical error 130 can randomly vary in every new position estimate in any GPS receiver. The size of mechanical error 126 is comparatively much smaller than the other two errors, which is highlighted by the relative sizes of the two circles in FIG. 1(a). Therefore, subsequent estimates of the same position by a given GPS receiver will remain confined to smaller circle 126 shown in the FIG. 1(a), representing the range of mechanical error 130.

In addition to the three errors described above, multipath error can significantly degrade the position estimation accuracy for any GPS receiver. Multipath error occurs when GPS signals arrive at the receiver antenna through multiple paths as a result of reflections from surrounding objects (e.g., high-rise buildings or overhead bridges). Multipath error is significant in urban areas where a roadway is surrounded by high-rise buildings. However, in rural and suburban areas, multipath error can be negligibly small and the significant errors are mechanical, ephemeris, and atmospheric, as described above.

FIG. 1(a) illustrates GPS receiver errors in static conditions. When such a GPS receiver is placed in a moving vehicle, it can be used to acquire a vehicle's trajectory by periodically estimating its position. This concept is illustrated in FIG. 1(b), where three adjacent GPS positions 130, 132 and 134 of a fast-moving vehicle on a freeway 136 (with minimal multipath error) are shown as dots centered in large circles 138, 140, and 142. Each adjacent estimated position 144, 146, and 148 will vary only within the small circles 150, 152 and 154 (the mechanical error range) as opposed to randomly changing over the larger circles 138, 140 and 142 because the atmospheric and ephemeris errors will remain the same for each estimate. Consequently, the trajectory obtained by the GPS receiver may vary randomly, but the maximum variations will be limited to the zigzag pattern 102, 104 shown in FIG. 1(b). The mean trajectory 106 obtained by the GPS receiver will have an offset from the true trajectory 108, but it will be a fixed offset and its size will be determined by the magnitude of net atmospheric and ephemeris error. Furthermore, the variance of the trajectory obtained by the GPS receiver will be determined by the magnitude of the mechanical error of the GPS receiver, which is generally small in size.

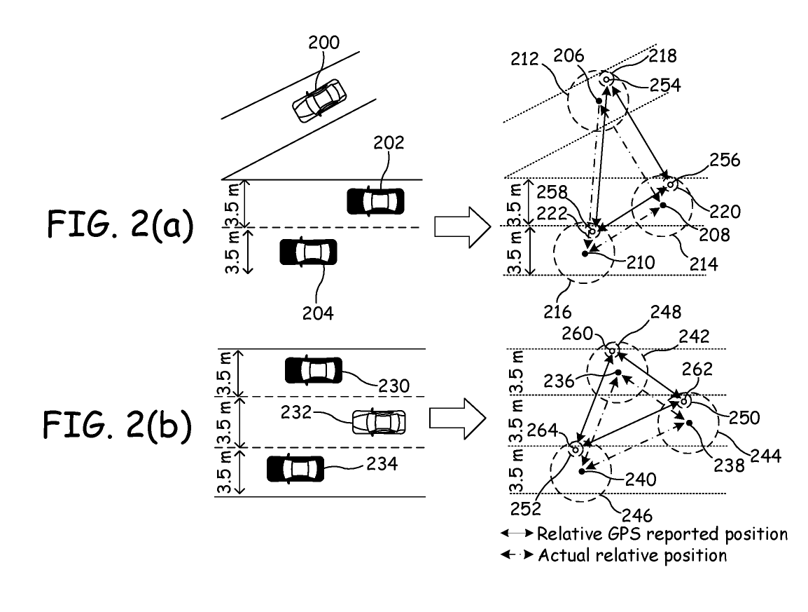

Similar to the trajectory of a single vehicle, which can be obtained by a GPS receiver with a small variance, the relative trajectories of multiple vehicles in close proximity that have their own GPS receivers can also be obtained with comparable variances. Two practical scenarios involving multiple vehicles—merging and changing lanes on freeway—are depicted in FIGS. 2(a) and 2(b). In both scenarios, the relative trajectories of surrounding vehicles, if accurately known, can be beneficial in the development of traffic safety applications. In FIG. 2(a), the actual positions of the vehicles 200, 202 and 204 are shown as respective dots 206, 208, and 210 in respective large circles 212, 214, and 216, where each large circle represents the total error in the GPS position and respective smaller circles 218, 220 and 222 represent the mechanical error in the GPS position. In FIG. 2(b), the actual positions of the vehicles 230, 232 and 234 are shown as respective dots 236, 238, and 240 in respective large circles 242, 244, and 246, where each large circle represents the total error in the GPS position and respective smaller circles 248, 250 and 252 represent the mechanical error in the GPS position. The estimated GPS position of vehicles 200, 202, 204, 230, 232, and 234 are shown by respective dots 254, 256, 258, 260, 262, and 264 and share the same offset from the true position because the net atmospheric and ephemeris error remains the same for all three vehicles—provided they are equipped with GPS receivers of the same model. Therefore, the relative distance and orientation between any two vehicles in both scenarios calculated from the estimated positions of the GPS receivers on the two vehicles will have a small variance determined by the mechanical errors of the GPS receivers. Specifically, subtracting the GPS position values of two vehicles from each other produces a vector providing an orientation of one of the vehicles relative to the other vehicle. The length of this vector provides the relative distance between the two vehicles. In both cases, the relative orientation and the relative distance are more accurate than the GPS position values for the two vehicles because taking the difference between the two positions reduces and in some cases completely removes the common atmospheric and ephemeris error in the GPS position values.

An accurate estimate of relative distance and orientation between any two vehicles at a given time can lead toward an accurate estimate of the relative trajectories of those vehicles with respect to each other. The trajectory for a single vehicle is determined by determining the difference between a GPS position value for the vehicle at one time and a GPS position value for the vehicle at an earlier time. Such trajectories are more accurate than the GPS position values they are formed from because the subtraction reduces and in some cases completely removes the common atmospheric and ephemeris errors in the two GPS position values. However, the computed trajectories do not contain accurate information about where they are positioned. In order to orient two trajectories relative to each other, a difference between the GPS position values of the two vehicles at the later time is determined to produce a vector between the two vehicle trajectories at that time. The length of that vector provides the distance between the two vehicle trajectories. Using the two vehicle trajectories, the orientation of the trajectories relative to each other and the distance between the ends of the trajectories, it is possible to determine if the paths of the two vehicles will intersect if the vehicles continue along their trajectories. This determination can be made in a binary fashion or in a probabilistic fashion where a likelihood of the two vehicle paths intersecting is determined.

The accuracy of the relative trajectories needs to be high enough for use in a potential safety application, such as a lane-merge or lane-change-assist system, where it is necessary to determine if a neighboring vehicle is in the same or adjacent lane.

### Characterization of the GPS Relative Distance Accuracy

The relative trajectories of surrounding vehicles can be obtained for any given vehicle on the road provided it can receive the estimated GPS positions of the neighboring vehicles. In accordance with one embodiment, DSRC-based V2V communication is used to exchange position information among surrounding vehicles that have GPS receivers, which allows GPS position data from neighboring vehicles to be processed in any vehicle to obtain relative trajectories.

Before conducting field tests to obtain relative trajectories of multiple vehicles on the road, the relative distance accuracy of standard GPS receivers built into the DSRC devices were characterized to determine if the relative distance accuracy is sufficient to distinguish the neighboring vehicles in the same or adjacent lanes. In accordance with one embodiment, the relative distance accuracy of the GPS receivers built in to the DSRC devices were statistically characterized and later the same devices were used to acquire the relative trajectories of multiple vehicles using DSRC-based V2V communication. In accordance with one embodiment, the built-in GPS receivers of the DSRC devices use a UBlox LEA-6 chipset, which is specified as having a ±2 m absolute position accuracy with 50 percent circular error probability (CEP). Using these GPS receivers, the various embodiments have been able to achieve a relative distance accuracy of ±0.5 m with 95 percent CEP.

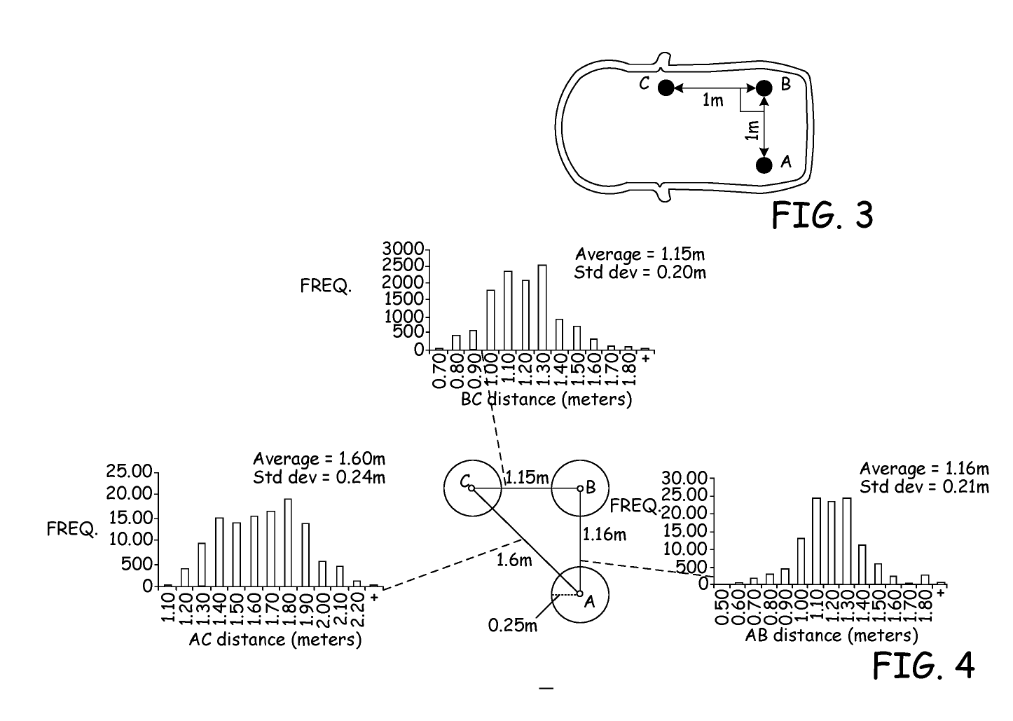

Field tests were conducted to statistically evaluate the accuracy of the relative distance obtained by the built-in GPS receivers of the DSRC devices. In one set of field tests, antennas for three DSRC devices were installed on top of one vehicle at locations A, B, and C, as shown in FIG. 3. The three locations formed a right-angle triangle with two shorter legs of length 1 m each. The equipped vehicle was driven on 1-35 near Duluth, Minn., in a round trip between exit #239 and #242 at a speed of about 70 MPH (speed limit) while continuously acquiring GPS position data in all three devices at the rate of 10 Hz.

The round trip was repeated six times, exchanging the positions of the antennas at locations A, B, and C after each trip and using all six possible permutations of the three devices. Each round trip produced three distinct sets of acquired GPS positions (one for each GPS receiver at location A, B and C) in terms of longitude and latitude at distinct time intervals synchronized with the GPS satellite time. There were more than 12,000 GPS points in each of the three sets of data (i.e., a net 20 minutes' worth of data with 10 Hz GPS acquisition rate). The data from all three DSRC devices was then processed to calculate three distances (AB, BC, and AC) for each set of three GPS points acquired at the same time because the clock of each GPS receiver was synchronized with the GPS satellite. The calculated average distances of AB, BC, and AC were 1.15, 1.16, and 1.6 m, with standard deviations of 0.21, 0.20, and 0.24 m, respectively, as shown in FIG. 4. The calculated average distances of AB, BC, and AC are shown in FIG. 4 where a circle with a 0.25 m radius is drawn at each location (A, B, and C) to indicate the spread of the calculated relative distance because the standard deviation of each calculated distance is less than 0.25 m. The variation of the relative distances of AB, BC, and AC is within ±0.5 m most of the time (>95%), as illustrated in the histogram of each segment in FIG. 4. Furthermore, the histograms show that the maximum spread of each relative distance is within a ±0.6 m limit (1.2 m total spread), which is still less than half of the lane width, and therefore, is sufficient to differentiate vehicles on adjacent lanes.

Although the specified absolute position accuracy of each GPS receiver used was ±2 m with 50 percent CEP, the relative position accuracy between any two GPS receivers was much improved because the net ephemeris and atmospheric error in absolute position was similar in all three GPS receivers and was therefore canceled out in the relative distance calculation.

One embodiment used standard GPS receivers of the same hardware and firmware model. This was done because the post processing of the GPS signal may vary among different GPS chips being used on different DSRC devices. The processing algorithm may also be different among different versions of firmware on the same kind of GPS chip. Furthermore, the GPS receiver's field of view is wide enough to receive signals from more than three or four GPS satellites, which is the minimum number of satellites required for two-dimensional or three-dimensional position calculation, respectively. In such scenarios, unless the post-processing algorithm of multiple GPS receivers is designed to lock to the same set of satellites, it is not guaranteed that the atmospheric and ephemeris errors will remain the same in each GPS receiver—thereby adversely affecting the relative distance accuracy.

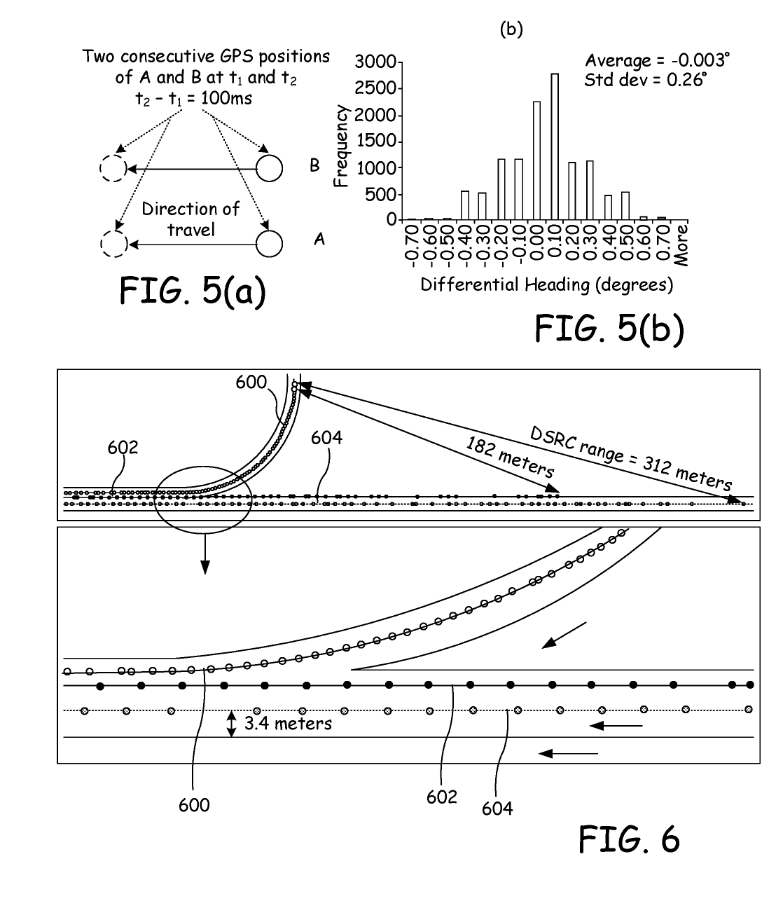

We also evaluated the directional accuracy for each of the GPS receivers in this field test. We took two consecutive GPS positions (100 msec apart in time) for each of the two GPS receivers at locations A and B of FIG. 3 and calculated individual headings for both, as shown in FIG. 5(a). FIG. 5(b) shows the histogram of a difference in headings of the GPS receivers at positions A and B for all available data points, covering six possible pairs of three distinct GPS receivers at two locations (A and B). The average and standard deviation of the differential heading is −0.003 degrees and 0.26 degrees, respectively. Both GPS receivers were traveling in the same direction, so the differential heading was expected to be zero. The results show that a standard GPS receiver can estimate the direction of travel with an accuracy of a quarter of a degree which is sufficient for use in a safety application e.g., a lane-change or merge-assist application. This is because a quarter of a degree mismatch between the actual and expected direction of travel of a vehicle traveling at 60 MPH will cause a displacement error of about 11 cm in its expected position after one second.

### Relative Trajectory Acquisition Using DSRC-Based V2V Communication

In accordance with one embodiment, DSRC devices with built-in GPS receivers were installed on three separate vehicles and were programmed to transmit and receive DSRC-based Basic Safety Messages (BSMs). Using those vehicles, we conducted field tests to demonstrate the acquisition of accurate relative vehicle trajectories traveling in different lanes.

We conducted the field tests around Exit #239 on 1-35 in Duluth, Minn., which is a two-lane freeway. One of the vehicles waited on the entrance ramp of Exit #239 to merge on the freeway while the other two vehicles traveled on the freeway toward the merging junction on two separate but adjacent lanes. When the two vehicles approached the merging junction, the vehicle waiting at the entrance ramp started to receive DSRC messages from the vehicles on the main freeway. Upon receiving the first message, the vehicle started to move and merged onto the freeway while continuing to receive DSRC messages from the two vehicles on the main freeway. The vehicle on the entrance ramp logged all of the received DSRC messages. This data was later analyzed to obtain relative trajectories of all three vehicles. We repeated the tests at least 12 times; each time, the acquired relative trajectories of the vehicles were accurate enough to identify each vehicle in its own lane.

One typical scenario of the field tests is shown in FIG. 6, where the acquired relative trajectories of three vehicles are drawn with line 600 representing the vehicle traveling on the entrance ramp, line 602 representing the vehicle traveling in the lane that merges with the entrance ramp, and line 604 representing the vehicle in the passing lane. The relative trajectories are superimposed onto Google Maps to establish a frame of reference. A zoomed-in version of the relative trajectories near the merge junction is shown in the bottom of FIG. 6, illustrating that lane-level accuracy can be achieved using the built-in standard GPS receivers of the DSRC devices.

To measure the range of the V2V communication during the field tests, we calculated the distance between the vehicles on the main freeway and the vehicle on the entrance ramp when that vehicle received the first DSRC messages from each of the two vehicles on the main freeway. The measured DSRC ranges for the DSRC devices on the two vehicles in the test scenario of FIG. 6 were 182 and 312 m, respectively. In the rest of the tests, the DSRC range typically varied between 200-300 m. The specified DSRC range is >500 m when a clear line of sight is available, but the actual achieved range (200-300 m) was reduced due to some natural growth around the merge junction that caused some loss of signal strength.

Although the relative trajectories obtained in the field tests were obtained by post-processing GPS data acquired through DSRC-based V2V communication during the field tests, in other embodiments the trajectory algorithm is executed within the DSRC device of the vehicle on the merging ramp to acquire the relative trajectories in real time. Using the real-time trajectories, speed, and direction of travel information from the relevant vehicles, embodiments estimate a safe merge time cushion to use in a merge assistance application.

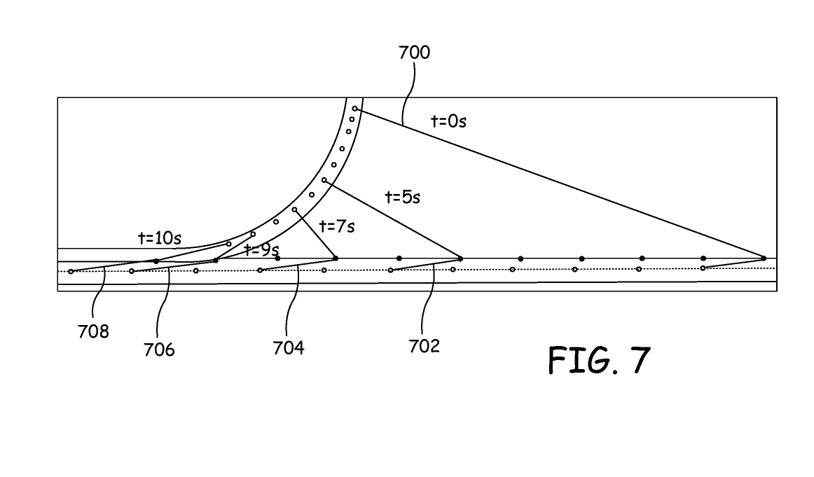

The merge time cushion is defined as the time it will take for a vehicle in the rightmost lane of the freeway to arrive at the merging junction after the vehicle on the entrance ramp has received the first BSM from this vehicle. The merge time cushion for the field test result of FIG. 6 was estimated to be between 9 and 10 seconds, as illustrated in FIG. 7, where lines 700, 702, 704, 706, and 708 each connect positions of the three vehicles at particular times. The time stamp t=0 s for line 700 in FIG. 7 indicates the time when the merging vehicle received the first BSM from the vehicle in the rightmost lane of the freeway. Similarly, the time stamp t=9 s for line 708 indicates the time when the vehicle in the rightmost lane of the main freeway arrives at the merging junction, giving the merging vehicle a merge time cushion of 9 seconds.

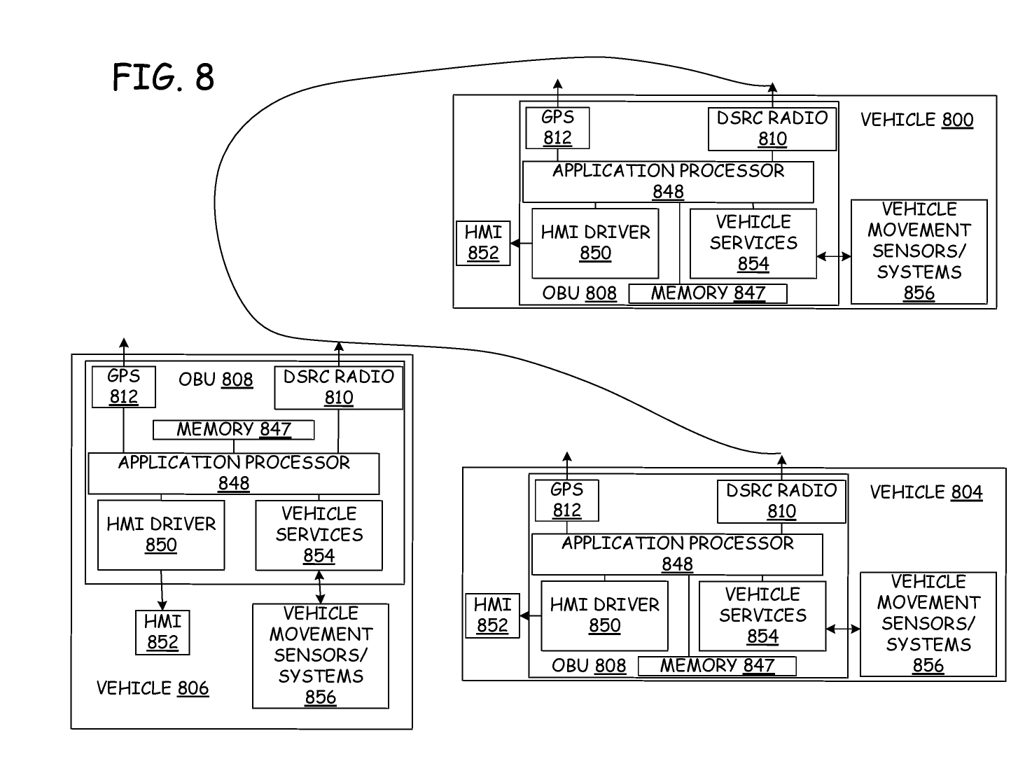

FIG. 8 provides a block diagram of three vehicles 800, 802 and 804, each equipped with a respective onboard unit 808 that includes a wireless communication radio 810, which in one embodiment is a dedicated short range communication (DSRC) radio, and a position system 812, which in one embodiment is a Global Positioning System (GPS) receiver.

Onboard units 808 also include an application processor 848 and a memory 847 where processor 848 executes instructions stored in memory 847 to perform a number of functions. For example, application processor 848 executes instructions that periodically request position coordinates of the respective vehicle from the vehicle's position system 812. Each obtained set of position coordinates has a degree of accuracy that is a function of the errors present in the determined coordinates including mechanical error, satellite ephemeris error and atmospheric error. In addition, each obtained set of position coordinates includes the time at which the coordinates were determined. The coordinates and their time stamps are stored in memory 847 so that they can be used to compute a trajectory for the vehicle as noted below.

For each obtained set of position coordinates, application processor 848 constructs and transmits a message that includes the position coordinates, the time at which the coordinates were determined and an identifier for the transmitting vehicle using respective radio 810. The transmitted messages are received by respective radios 810 in the other vehicles that are within range of transmitting radio 810. The receiving radios 810 provide the received message to the receiving radio's respective application processor 848, which decodes the message to acquire the position coordinates, the time stamp and the vehicle identifier transmitted by the transmitting vehicle. The position coordinates received from the transmitting vehicle have the same degree of accuracy as the transmitted coordinates and include the mechanical error, the satellite ephemeris error and the atmospheric error.

Each time an application processor 848 receives coordinates from another vehicle, application processor 848 updates relative trajectories of the vehicle that transmitted the coordinates and the vehicle that the application processor 848 is located in. In one embodiment, the trajectory of the receiving vehicle is updated by determining a difference between previous coordinates of the receiving vehicle provided by onboard positioning system 812 and the last-determined coordinates of the receiving vehicle provided by onboard positioning system 812. This difference provides the trajectory of the receiving vehicle but not the location of the receiving vehicle. Taking the difference between these two coordinates removes the common satellite ephemeris error and the common atmospheric error present in the previous coordinates and last-determined coordinates such that the trajectory represented by the difference is more accurate than either of the two coordinates used to form the trajectory.

Similarly, the trajectory of the transmitting vehicle is updated by determining a difference between previous coordinates for the transmitting vehicle and the last-received coordinates of the transmitting vehicle. This also provides a trajectory for the transmitting vehicle but not the position of the transmitting vehicle. Taking the difference between these two coordinates removes the common satellite ephemeris error and the common atmospheric error present in the previous coordinates for the transmitting vehicle and last-determined coordinates for the transmitting vehicle such that the trajectory represented by the difference is more accurate than either of the two coordinates used to form the trajectory.

The position of the transmitting vehicle relative to the receiving vehicle is then determined by taking the difference between the last-received coordinates from the transmitting vehicle and the last-determined coordinates provided by the onboard positioning system 812 of the receiving vehicle. The last-received coordinates from the transmitting vehicle and the last-determined coordinates provided by onboard positioning system 812 were determined for a common time point and thus reflect the positions of the transmitting vehicle and receiving vehicle at a same point in time. The difference between the last-received coordinates from the transmitting vehicle and the last-determined coordinates provided by onboard positioning system 812 provide a relative distance and orientation between the two vehicles but does not provide an absolute position for either vehicle. Taking the difference between these two coordinates removes the common satellite ephemeris error and the common atmospheric error present in the last-received coordinates for the transmitting vehicle and last-determined coordinates for the transmitting vehicle such that the distance and orientation between the coordinates is more accurate than either of the two coordinates used to form the distance and orientation.

The relative distance and orientation between the two vehicles can then be combined with the computed trajectories of the two vehicles to determine whether the paths of the two vehicles will intersect in the future. In one embodiment, this determination is probabilistic such that a likelihood of the paths intersecting is determined based on the trajectories, the relative orientation and distance between the vehicles and the roadways near the two vehicles. If the likelihood is high enough, application processor 848 instructs a Human-Machine Interface (HMI) driver 850 to provide an indication that the paths will intersect on a Human-Machine Interface (HMI) 852. HMI 852 may be an audio device, a display device or a combination of an audio and display device. In accordance with one embodiment, HMI 852 is a display that shows a depiction of a section of a map with graphics depicting the general locations of the two vehicles on the map and the trajectories of the two vehicles as determined above. In a further embodiment, HMI 852 provides an indication of the amount of time it will take for one or both of the vehicles to reach the point where the paths of the vehicles will intersect. This will give a driver of a vehicle an idea of whether there is enough time for the driver to merge/cross at the point of intersection or whether the driver should slow down and allow the other vehicle to pass first.

Although the trajectories and relative positions and orientations are discussed above for a receiving vehicle that receives coordinates from a single transmitting vehicle, in other embodiments, the receiving vehicle receives coordinates from a plurality of transmitting vehicles and computes trajectories and relative positions and orientations of each transmitting vehicle relative to the receiving vehicle.

Vehicles 800, 802, and 804 also include vehicle movement sensors/systems 856, which provides information about the vehicle such as the current speed of the vehicle, the status of various vehicle components such as tires, lights, brakes, wipers, and the orientation of the tires, for example. This information is provided to a vehicle services module 854 in onboard unit 808, which provides the information to application processor 848.

Although the present invention has been described with reference to preferred embodiments, workers skilled in the art will recognize that changes may be made in form and detail without departing from the spirit and scope of the invention.

What is claimed is:

1. A method comprising:
receiving at a first vehicle, position coordinates from a second vehicle using a dedicated short range communication protocol, the position coordinates from the second vehicle comprising an error;
receiving from a positioning system in the first vehicle position coordinates for the first vehicle, the position coordinates for the first vehicle comprising the error; and
using the position coordinates from the second vehicle and the position coordinates from the first vehicle to determine a relative distance and orientation between the first vehicle and the second vehicle such that the error is reduced in the relative distance and orientation.

2. The method of claim 1 further comprising:
before receiving the position coordinates from the second vehicle, receiving previous position coordinates from the second vehicle; and
after receiving the position coordinates from the second vehicle determining a trajectory for the second vehicle from the position coordinates from the second vehicle and the previous position coordinates from the second vehicle.

3. The method of claim 2 wherein the determined trajectory for the second vehicle is more accurate than the position coordinates from the second vehicle.

4. The method of claim 2 further comprising:
before receiving the position coordinates for the first vehicle, receiving previous position coordinates for the first vehicle; and
after receiving the position coordinates for the first vehicle determining a trajectory for the first vehicle from the position coordinates for the first vehicle and the previous position coordinates for the first vehicle.

5. The method of claim 4 wherein the determined trajectory for the first vehicle is more accurate than the position coordinates for the first vehicle.

6. The method of claim 4 further comprising using the determined trajectory for the second vehicle, the determined trajectory for the first vehicle, and the distance and orientation between the first vehicle and the second vehicle to determine whether the paths of the first vehicle and the second vehicle will intersect in the future.

7. The method of claim 6 further comprising when it is determined that the paths of the first vehicle and the second vehicle will intersect in the future, providing an interface to an occupant of the first vehicle indicating the future intersection of the paths of the first and second vehicle.

8. The method of claim 7 wherein providing the interface comprises providing a time until the second vehicle will reach the intersection of the paths.

9. A vehicle comprising:
a positioning system providing coordinates for a position of the vehicle, the coordinates having a first accuracy;
a communication system receiving coordinates for a position of a second vehicle from the second vehicle; and
a processor, using the coordinates for the position of the vehicle and the coordinates for the position of the second vehicle to determine a distance between the vehicle and the second vehicle, the distance having a second accuracy that is more accurate than the first accuracy.

10. The vehicle of claim 9 wherein the positioning system provides second coordinates for a second position of the vehicle, the second coordinates having the first accuracy and wherein the processor further uses the coordinates and the second coordinates for the vehicle to determine a trajectory for the vehicle.

11. The vehicle of claim 10 wherein the trajectory for the vehicle has an accuracy that is more accurate than the first accuracy.

12. The vehicle of claim 10 wherein the communication system receives second coordinates for a second position of the second vehicle and wherein the processor further uses the coordinates and second coordinates for the second vehicle to determine a trajectory for the second vehicle.

13. The vehicle of claim 12 wherein the trajectory for the second vehicle has an accuracy that is more accurate than the first accuracy.

14. The vehicle of claim 9 wherein the positioning system is a Global Positioning System.

15. The vehicle of claim 14 wherein the communication system receives coordinates for positions of multiple vehicles from the respective multiple vehicles.

16. A system comprising:
a position system that identifies a position of a vehicle, where the identified position includes an error;
a communication system that transmits the position of the vehicle and that receives a position of a second vehicle, where the received position of the second vehicle includes the same error as the identified position of the vehicle; and
a processor that uses the identified positions of the vehicle and the second vehicle to determine a distance and orientation of the second vehicle relative to the first vehicle such that the error is reduced in the distance and orientation.

17. The system of claim 16 wherein the position system identifies a second position of the vehicle and the identified second position includes the error and wherein the processor determines a trajectory of the vehicle from the identified position and the identified second position such that the error is reduced in the trajectory.

18. The system of claim 17 wherein the communication system receives a second position of the second vehicle and the received second position includes the error and wherein the processor determines a trajectory of the second vehicle from the received position and the received second position such that the error is reduced in the trajectory of the second vehicle.

19. The system of claim 18 wherein the processor uses the trajectory of the vehicle and the trajectory of the second vehicle to determine whether a path of the vehicle will intersect a path of the second vehicle.

20. The system of claim 19 wherein the position system comprises a satellite-based position system and the error is related to at least one satellite.

21. The system of claim 20 wherein the received position of the second vehicle comprises a position from a satellite-based position system.
